(19) United States
(12) Patent Application Publication
(10) Pub. No.: US 2014/0196671 A1
(43) Pub. Date: Jul. 17, 2014

(54) COLLAPSIBLE TACTILE MAZE PET TOY

(71) Applicant: Dale Taylor, Centennial, CO (US)

(72) Inventor: Dale Taylor, Centennial, CO (US)

(21) Appl. No.: 13/740,232

(22) Filed: Jan. 13, 2013

(51) Int. Cl. A01K 15/02; A63F 9/00

(52) U.S. Cl. CPC A01K 15/025; A63F 9/0078
USPC 119/707; 273/153 R

(57) ABSTRACT

The invention relates to a novel pet toy that utilizes tactile signals to solve the maze puzzle and is collapsible allowing for compaction during play. Soft sides allow for compaction and reconfigurable inner walls create a potentially new and unique trajectory for the solver of the maze. A treat may be placed inside for reward motivation and to activate sensory triggers of an animal though the toy could be utilized by a human child as well.

### FIELD

The invention relates to a novel pet toy that utilizes tactile signals to solve the maze puzzle and is collapsible allowing for compaction during play.

### BACKGROUND OF THE INVENTION

The invention most closely corresponds with USPTO Class 446 which addresses pet toys in general, and subclass 4 having parts that are knocked awry by impact.

In its simplest form, the invention comprises a novel pet maze puzzle that utilizes tactile signals to aid in solving the “maze” wherein an animal (or child) must use limbs to proceed through portions of the maze that are not “dead-ends”. Toys which rely on tactile function utilize the educational psychology associated with touch and memory.

### THE INVENTION

### Summary, Objects and Advantages

Educational psychology tells us that memory is organization of thought that allows a human (or an animal) to make decisions and solve problems. Haptic (or tactile) memory refers to the recollection of data acquired by touch after a stimulus has been presented.

Tactile memories are organized somatotopically, following the organization of the somatosensory cortex. This means that areas close on the body surface receive nervous signals from areas that are close together on the brain surface. Several distinct areas of the parietal lobe are responsible for contributing to different aspects of haptic memory. Memory for the properties of stimuli such as roughness, spatial density, and texture involves activation of the parietal operculum. Properties of stimuli such as size and shape, as detected by touch receptors in the skin, are stored in the anterior part of the parietal lobe.

What this means, in plain English, is that an animal (or a child) will respond to objects touched; store that data to memory, and act upon that data in some fashion. In the present invention, tactile “clues” such as varying textures or shapes will assist in finding a way through the maze by inducing memory triggers. None of the clues can be seen due to the maze being enclosed top, bottom, and sides. Thus tactile sense is relied upon completely to discover and process clues.

The tactile maze contains corridors whether squared or rounded, that will alternately lead to further passage, or a dead-end. Varying textures will provide tactile clues that an animal (or child) will recognize in short term memory as being access related or not. The inner walls are removable and re-attachable so that a variance of trajectories can be produced. This retains interest and engagement of the maze solver.

Ideally the maze is constructed of softer material slightly bolstered for stability wherein impact will cause the maze corridors or tunnels to compact to a degree so that reach may be achieved. The maze will not collapse completely, but compact so that it can be solved utilizing a small space footprint.

The mazes can vary in size but the disclosed embodiment, for basic visualization, is approximately 12 twelve inches by 16 inches. This is by no means a limitation in terms of potential for producing a larger maze for larger pets or even children, and such variances should be apparent and obvious options for this inventive toy.

### BRIEF DESCRIPTION OF THE DRAWINGS

The invention is described in further detail by reference to five (5) drawings sufficient in detail to describe the invention in which:

FIG. 1 is a top perspective of the maze uncovered for internal illustration;

FIG. 2 is an illustration showing maze corridors as removable;

FIG. 3 is an external view of the maze and pet accessing it;

FIG. 4 is a demonstrative illustration of the collapsing feature; and

FIG. 5 is an example of the resultant reward to the animal

### DETAILED DESCRIPTION, INCLUDING BEST MODES OF CARRYING OUT THE INVENTION

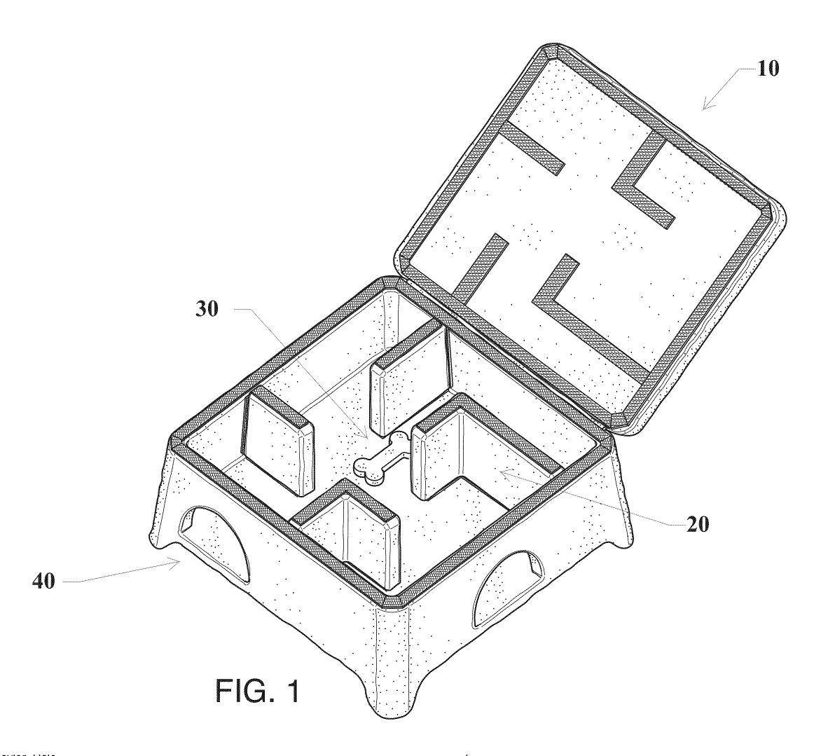

FIG. 1 is a basic illustration of the maze 10 with the top portion open for the purposes of revealing the maze corridors 20 as they would be affixed within. The corridors are attached via Velcro-type connections and removable so that the maze can be reconfigured in order to further challenge the solver. Here, a treat 30 is shown as the object of the maze solution wherein an animal would smell the treat and pursue via sensory and tactile methods. Access apertures are shown 40 wherein an animal's snout or paw can be inserted. A human hand may most certainly be used as well.

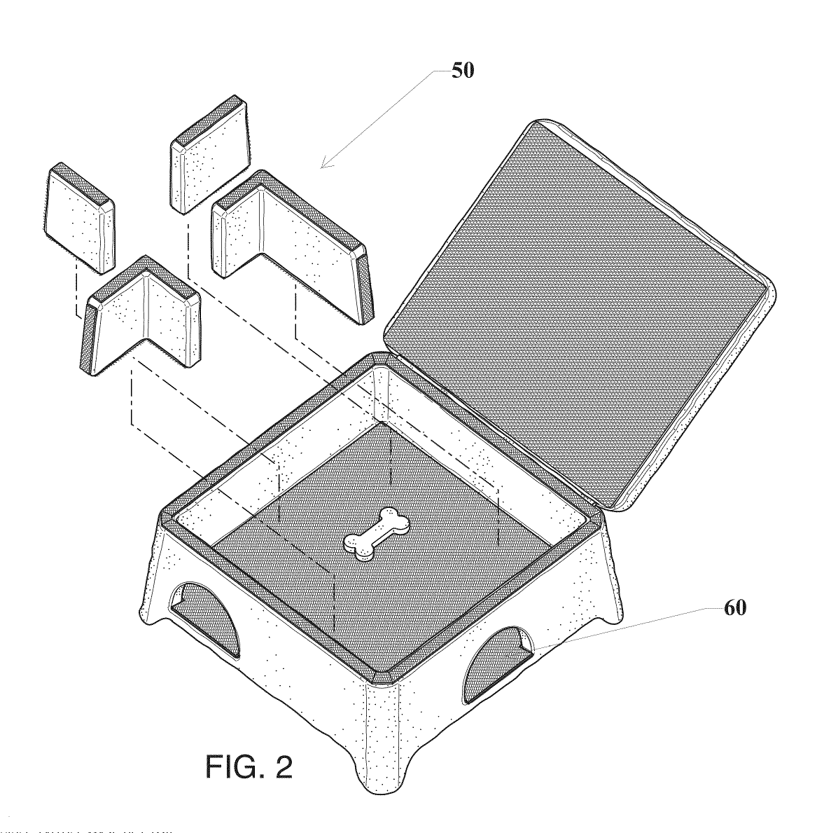

FIG. 2 illustrates the maze corridors 50 as detachable and thus may be reconfigured to challenge the solver. The base of the maze 60 allows for adhesion by a Velcro-type affixation of the corridors to said base consisting of a receiving fabric. Pieces may be quickly removed and reaffixed to create an alternate trajectory within the maze.

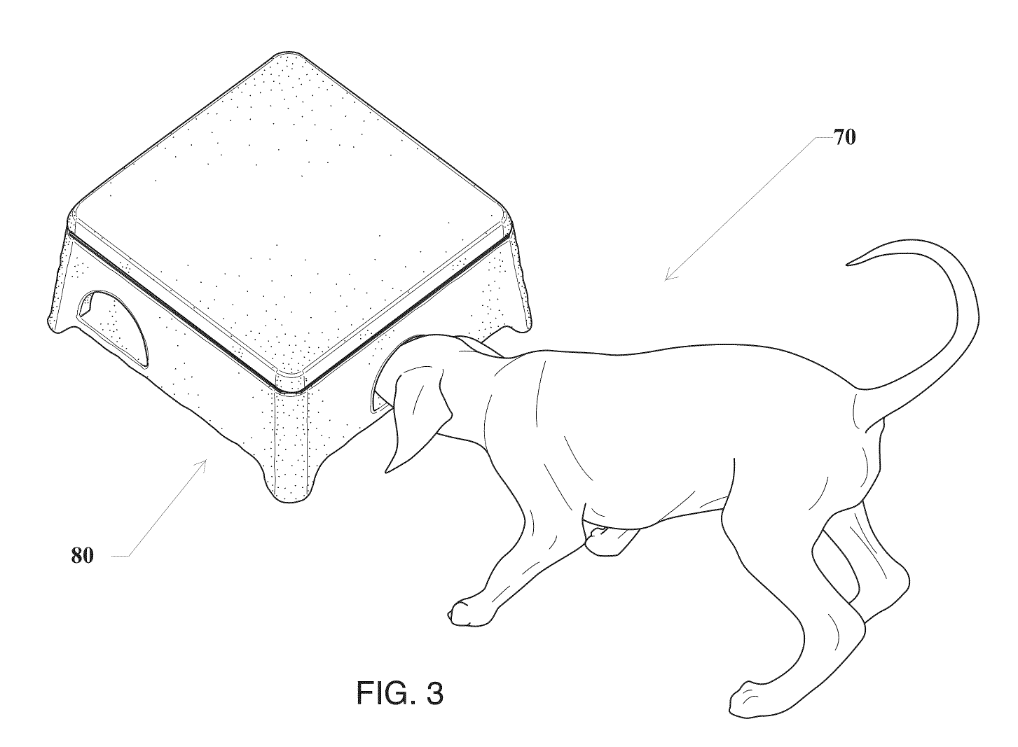

FIG. 3 illustrates a dog 70 inserting its snout into the maze 80 as enticed by the scent of the aforementioned treat. Thus the animal will use its sensory and tactile skills to pursue the scent trail. As the dog applies pressure, the maze will deform or collapse under the pressure.

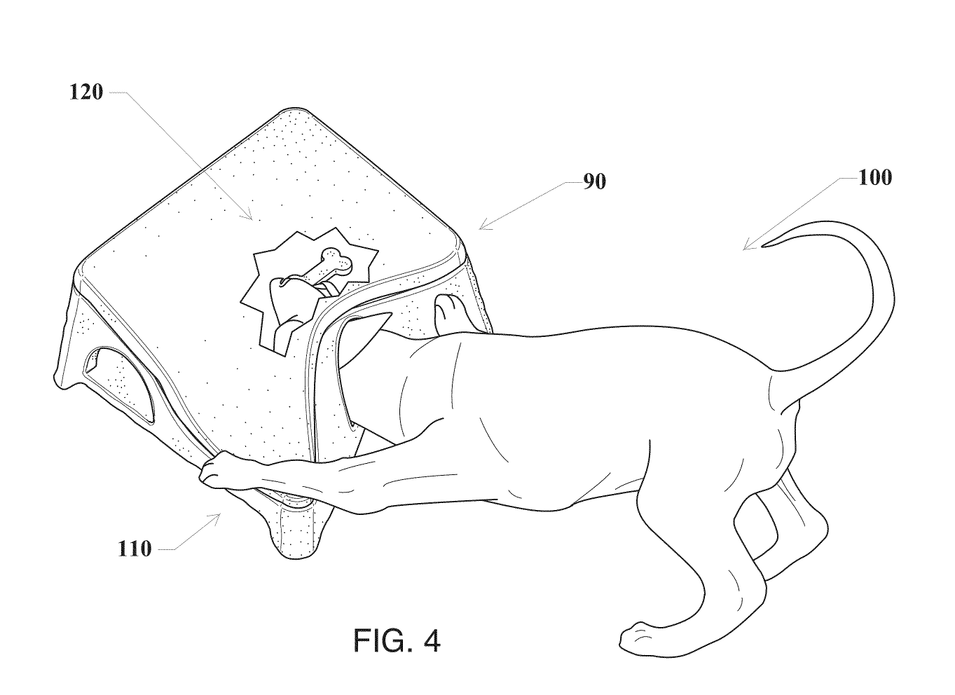

FIG. 4 is a basic example of the collapsible nature of the maze 90 as responding to pressure applied by the dog 100. The maze can be held in place by the animal 110 as shown and as per a natural instinct to restrict the object of its attention. During this process, the animal cannot see the object treat and must navigate through the aforementioned corridors to find the treat shown here in cut-out 120.

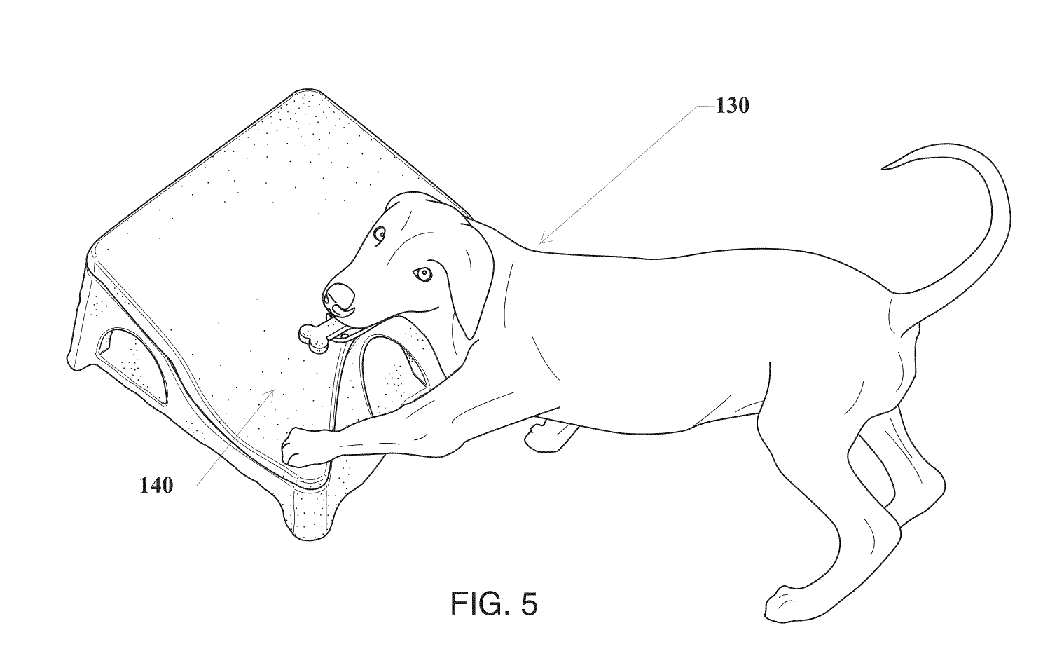

FIG. 5 is intended as a lighthearted illustration of a very pleased pet 130 who has solved the maze utilizing its tactile skills and produced its “treat” 140. Once operant conditioning occurs and the dog has “memorized” the corridors, the corridors can be reconfigured to create a new challenge for solving the maze. This makes the inventive toy an appealing item for consumers as it will continue to motivate the solver as a result of the changing solutions.

1) A maze toy comprising;
a) access apertures for solver access
b) collapsible frame and inner walls
c) configurable inner walls
d) fixation means on floor of maze

2) The maze toy of claim 1 wherein the access apertures are openings on one or more sides of the maze to allow access by a maze solver.

3) The maze toy of claim 1 wherein the frame and inner walls of the maze are soft and collapsible under pressure by solver.

4) The maze toy of claim 1 wherein the inner walls are configurable by removal and replacement and can vary in surface texture.

5) The maze toy of claim 1 wherein the fixation means is a Velcro-type affixation which allows for removal and replacement of the inner walls of the maze as affixed to the floor of the maze.
